(19) United States
(12) Patent Application Publication
(10) Pub. No.: US 2025/0317025 A1
(43) Pub. Date: Oct. 9, 2025

(54) TERMINAL OF BUSBAR AND MOTOR INCLUDING THE SAME

(71) Applicants: HL MANDO CORPORATION, Pyeongtaek-si, Gyeonggi-do (KR); TRANIT CO., LTD., Suwon-si (KR)

(72) Inventors: Ji Hoon KIM, Pyeongtaek-si (KR); Seung Ro LEE, Suwon-si (KR)

(73) Assignees: HL MANDO CORPORATION, Pyeongtaek-si, Gyeonggi-do (KR); TRANIT CO., LTD., Suwon-si, Gyeonggi-do (KR)

(21) Appl. No.: 18/904,431

(22) Filed: Oct. 2, 2024

(30) Foreign Application Priority Data
Apr. 9, 2024 (KR) 10-2024-0048344

(51) Int. Cl. H02K 5/22; H02G 5/02; H02K 1/16

(52) U.S. Cl. CPC H02K 5/225; H02G 5/02; H02K 1/16

(57) ABSTRACT

The present embodiments relate to a terminal of a busbar and a motor including the same. More specifically, there may be provided a terminal of a busbar that may reduce the amount of scraps generated during press processing as the connection terminal is formed side by side with the body portion in a twist-bendable shape to thereby reduce material costs and may increase rigidity as the connection terminal is twist-bent in a direction of crossing the body portion during assembly, and a motor including the same.

### CROSS-REFERENCE TO RELATED APPLICATION

This application claims priority from Korean Patent Application No. 10-2024-0048344, filed on Apr. 9, 2024, which is hereby incorporated by reference for all purposes as if fully set forth herein.

### BACKGROUND

### Field

The present embodiments relate to a terminal of a busbar that may reduce the amount of scraps generated during press processing and increase rigidity during assembly, and a motor including the same.

### Description of Related Art

In general, an electronic power steering system (EPS) allows an electronic control unit (ECU) to drive a motor according to driving conditions detected through a vehicle velocity sensor, torque angle sensor, and torque sensor to ensure turning stability and provide rapid restoring force, thereby enabling the driver to drive safely.

The motor used in such an electric power steering system includes a housing which has a cylindrical shape and has an open top and a bracket coupled to the upper portion of the housing, which form the outer appearance, a stator installed in the housing, and a rotor installed inside the stator to rotate according to electromagnetic interaction with the stator.

The rotor is rotatably supported by a shaft, which provides power to assist steering to the vehicle.

Specifically, the stator has a plurality of coil-wound cores assembled in a cylindrical shape, and a busbar having a plurality of terminals is coupled to the upper portion of the stator. In this case, an end of the coil wound on each core protrudes upward to connect to the terminal of the busbar.

The busbar includes a terminal holder and a terminal. The terminal includes a body portion supported on the terminal holder, a connection terminal branched upward from the body portion to electrically connect to a power supply unit, and a plurality of binding terminals branched from the body portion and protruding radially of the terminal holder to connect to the end of the coil.

The terminal may be manufactured by punching a sheet metal material into a net pattern by press processing. The shape of the conventional terminal is formed so that the body portion and the connection terminal are perpendicular, i.e., the connection terminal crossing the body portion, causing lots of scraps.

### SUMMARY

The present embodiments may provide a terminal of a busbar that may reduce the amount of scraps generated during press processing as the connection terminal is formed side by side with the body portion in a twist-bendable shape to thereby reduce material costs and may increase rigidity as the connection terminal is twist-bent in a direction of crossing the body portion during assembly, and a motor including the same.

In an aspect, the present embodiments may provide a terminal of a busbar, comprising a body portion bent with a predetermined curvature and supported by a terminal holder of a motor, a connection terminal formed side by side with the body portion in a length direction of the body portion, having an end portion bent upward to be electrically connected to a power supply unit and connect to a coil, and a plurality of binding terminals extending from a portion of the body portion and protruding radially of the terminal holder, wherein the connection terminal includes a support portion connected to one side of the body portion through a first bent line and, when assembled, bent in an outward or inward direction of the terminal holder; a first connection portion connected to one side of the support portion through a second bent line and, when assembled, bent in a length direction of the body portion, a first bent portion connected to one side of the first connection portion through a third bent line and, when assembled, bent in an outward or inward direction of the terminal holder, and a contact portion connected to one side of the first bent portion through a fourth bent line and, when assembled, spaced apart from the first connection portion by a predetermined gap and bent in a direction facing the first connection portion.

In another aspect, the present embodiments may provide a terminal of a busbar, comprising a body portion bent with a predetermined curvature and supported by a terminal holder of a motor and a connection terminal formed side by side with the body portion in a length direction of the body portion, having an end portion bent upward to be electrically connected to a power supply unit and connect to a coil.

In another aspect, the present embodiments may provide a motor, comprising a rotor coupled to a shaft, a stator including a core disposed outside of the rotor, a winding portion mounted on the core, and a stator including a coil wound on the winding portion, and a busbar including a plurality of phase terminals and a plurality of neutral terminals connecting to the coil and a terminal holder disposed on an upper side of the stator to support the phase terminals and the neutral terminals, wherein one or more of the plurality of phase terminals include a body portion bent with a predetermined curvature along a circumferential direction and supported by the terminal holder and a connection terminal formed side by side with the body portion in a length direction of the body portion and having an end portion bent upward to be electrically connected to a power supply unit.

According to the present embodiments, there may be provided a terminal of a busbar that may reduce the amount of scraps generated during press processing as the connection terminal is formed side by side with the body portion in a twist-bendable shape to thereby reduce material costs and may increase rigidity as the connection terminal is twist-bent in a direction of crossing the body portion during assembly, and a motor including the same.

### BRIEF DESCRIPTION OF THE DRAWINGS

The above and other objects, features, and advantages of the present disclosure will be more clearly understood from the following detailed description, taken in conjunction with the accompanying drawings, in which:

FIG. 1 is a view illustrating a portion of a motor;

FIG. 2 is an exploded perspective view illustrating a portion of a motor;

FIG. 3 is a perspective view illustrating a folded state of a terminal of a busbar;

FIG. 4 is a perspective view illustrating a folded state of a portion of a terminal of a busbar according to an embodiment;

FIG. 5 is a perspective view illustrating a folded state of a terminal of a busbar according to an embodiment;

FIG. 6 is a perspective view illustrating a folded state of a portion of a terminal of a busbar according to another embodiment;

FIG. 7 is a perspective view illustrating a folded state of a terminal of a busbar according to yet another embodiment;

FIG. 8 is a perspective view illustrating a folded state of a neutral terminal of a busbar;

FIG. 9 is a plan view illustrating a state in which a terminal of a busbar is punched into a net pattern on a sheet plate material by press processing;

FIG. 10 is a plan view illustrating a state in which a terminal of a busbar is punched into a net pattern on a sheet plate material by press processing according to an embodiment; and

FIG. 11 is a plan view illustrating a state in which a terminal of a busbar is punched into a net pattern on a sheet plate material by press processing according to another embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

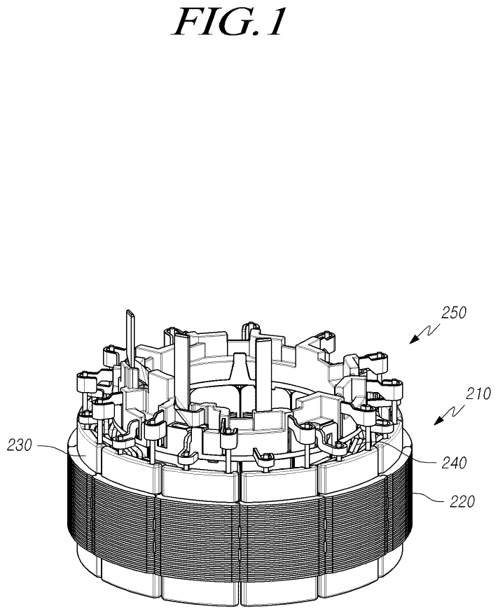

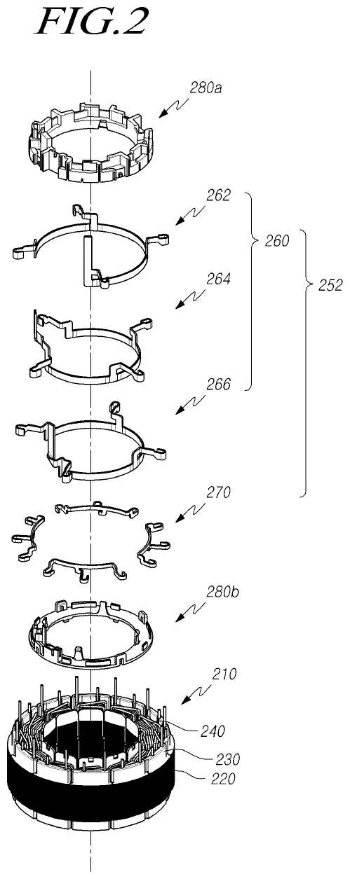

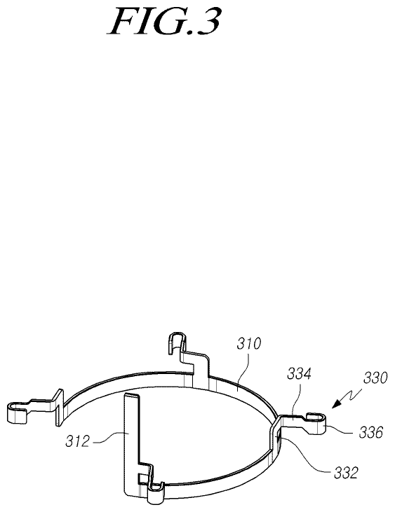

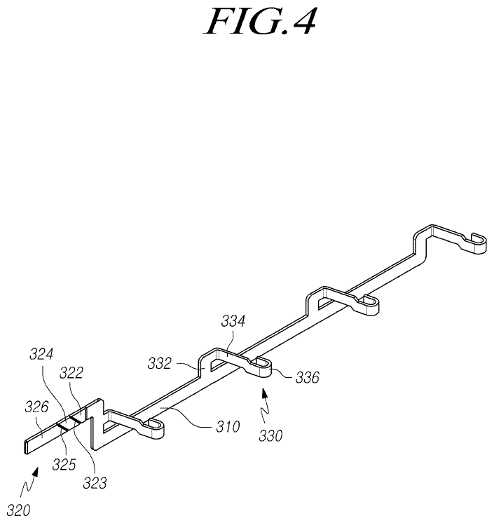

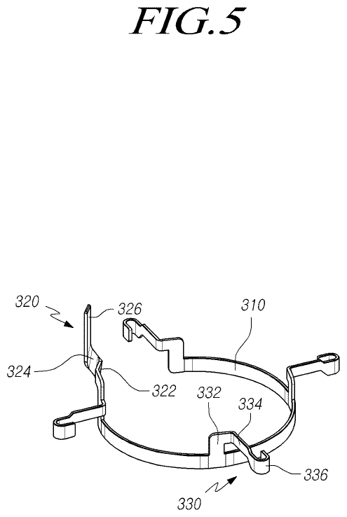

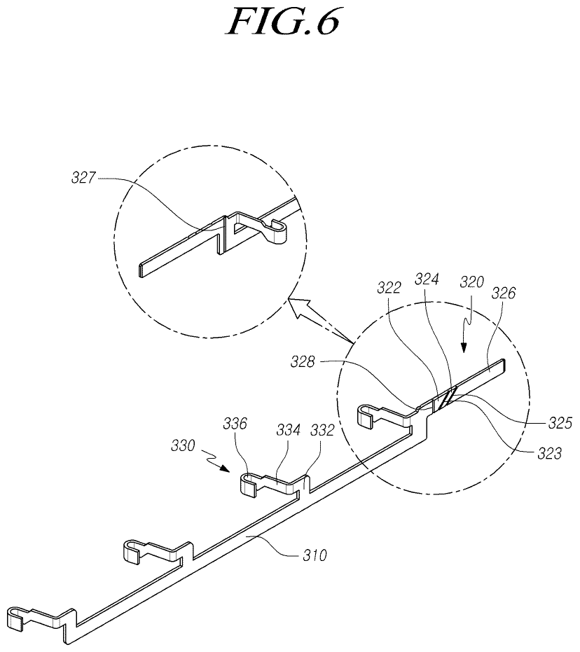

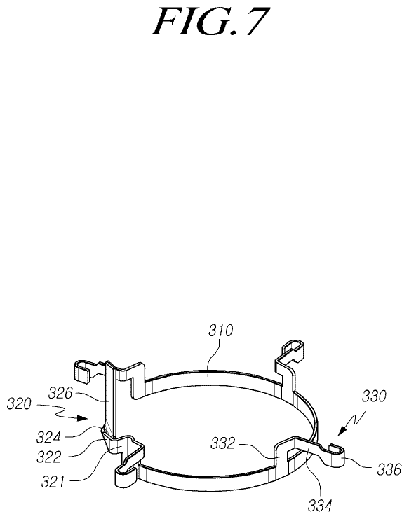

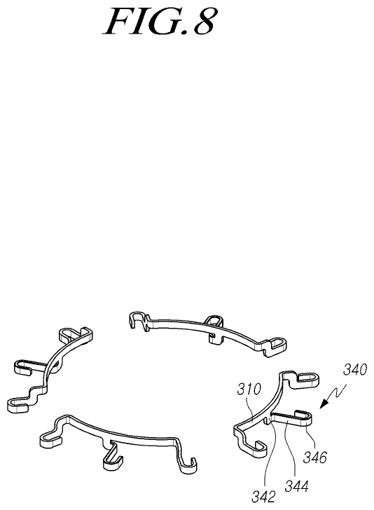

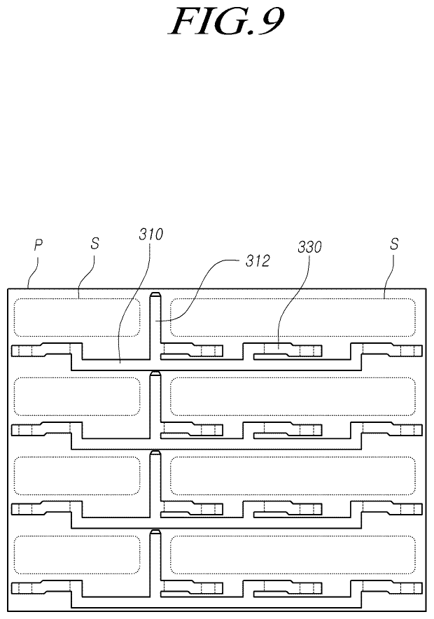

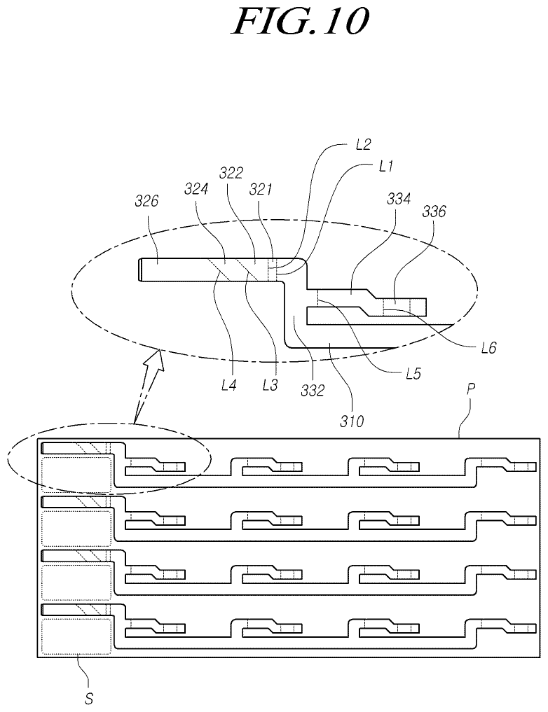

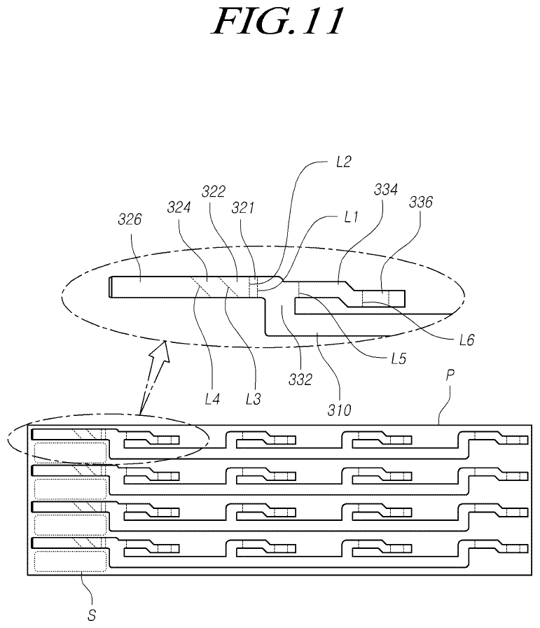

FIG. 1 is a view illustrating a portion of a motor. FIG. 2 is an exploded perspective view illustrating a portion of a motor. FIG. 3 is a perspective view illustrating a folded state of a terminal of a busbar. FIG. 4 is a perspective view illustrating a folded state of a portion of a terminal of a busbar according to an embodiment. FIG. 5 is a perspective view illustrating a folded state of a terminal of a busbar according to an embodiment. FIG. 6 is a perspective view illustrating a folded state of a portion of a terminal of a busbar according to another embodiment. FIG. 7 is a perspective view illustrating a folded state of a terminal of a busbar according to another embodiment. FIG. 8 is a perspective view illustrating a folded state of a neutral terminal of a busbar. FIG. 9 is a plan view illustrating a state in which a terminal of a busbar is punched into a net pattern on a sheet plate material by press processing. FIG. 10 is a plan view illustrating a state in which a terminal of a busbar is punched into a net pattern on a sheet plate material by press processing according to an embodiment. FIG. 11 is a plan view illustrating a state in which a terminal of a busbar is punched into a net pattern on a sheet plate material by press processing according to another embodiment.

Referring to FIGS. 1 and 2, a motor according to the present embodiments may include a rotor coupled to a shaft, a stator 210 including a core 220 disposed outside of the rotor, a winding portion 230 mounted on the core 220, and a stator 210 including a coil 240 wound on the winding portion 230, and a busbar 250 including a plurality of phase terminals 260 and a plurality of neutral terminals 270 connecting to the coil 240 and a terminal holder 280a and 280b disposed on an upper side of the stator to support the phase terminals 260 and the neutral terminals 270. One or more of the plurality of phase terminals 260 may include a body portion 310 bent with a predetermined curvature along a circumferential direction and supported by the terminal holder 280a and 280b, a connection terminal 320 formed side by side with the body portion 310 in a length direction of the body portion 310 and having an end portion bent upward to be electrically connected to an external device to receive a power supply, and a plurality of binding terminals 330 extending from a portion of the body portion 310 and protruding radially of the terminal holder 280a and 280b.

The motor includes a housing which has a cylindrical shape and has an open top and a bracket coupled to the upper portion of the housing, which form the outer appearance, a stator 210 installed in the housing, and a rotor installed inside the stator 210 to rotate according to electromagnetic interaction with the stator 210.

The rotor is rotatably supported by a shaft, which provides power to assist steering to the vehicle.

If the motor generates electromagnetic interaction between the rotor and the stator 210 through current supply, the rotor rotates, and in conjunction with this, the shaft rotates, providing power to assist steering to the vehicle.

The shaft is coupled to the rotor and rotatably supports the rotor, and the rotor rotates through electrical interaction with the stator 210.

The stator 210 includes a core 220 disposed outside the rotor, a winding portion 230 mounted on the core 220, and a coil 240 wound on the winding portion 230.

A plurality of winding portions 230 may be formed from the outer circumferential surface toward the hollow to be wound by the coil 240, and the coil 240 is wound on the plurality of winding portions 230. Specifically, coils 240 receiving three different types of power are wound.

The three different types of power mean power sources having 120-degree phase differences (U, V, and W phases) and, in the present embodiments, four U-phase power sources, four V-phase power sources, and four W-phase power sources are sequentially and alternately arranged along the circumferential direction.

The coils 240 have any one of the U, V, and W three-phase power lines and a neutral line, sequentially and alternately arranged along the circumferential direction, and a power line connected to the U-phase power source or V-phase power source or W-phase power source and a neutral line connected to the neutral point are drawn out.

The busbar 250 includes a plurality of phase terminals 260 and a plurality of neutral terminals 270 connected to the coil 240 and a terminal holder 280a and 280b disposed on an upper side of the stator 210 to support the plurality of phase terminals 260 and the plurality of neutral terminals 270.

The plurality of phase terminals 260 include a first phase terminal 262 connected to any one of three-phase power lines of U, V, and W, a second phase terminal 264 connected to another, and a third phase terminal 266 connected to the other.

The terminal holder 280a and 280b forms the outer appearance of the busbar 250 and are formed in a hollow donut shape.

The terminal holder 280a and 280b is formed of an insulating material, and has a plurality of recesses into which the terminals are inserted.

In this case, the same number of recesses as the number of terminals are formed along the circumferential direction, and in the present embodiments, three phase terminal recesses into which the phase terminals 260 to be connected to the respective phases U, V, and W of the three-phase power sources are inserted and neutral terminal recesses into which the four neutral terminals 270 are inserted are formed.

The numbers of phase terminal recesses and neutral terminal recesses may be variously selected according to the designer's intention and the number of terminals 252.

As illustrated in FIG. 3, the phase terminal 260 according to an embodiment includes a body portion 310 bent with a predetermined curvature along the circumferential direction of the terminal holder 280a and 280b to be supported by the terminal holder 280a and 280b, an end portion 312 of a connection terminal 320 branched upward from the body portion 310 to face upward and electrically connected to an external device (e.g., a power supply unit) to receive a power supply, and a plurality of binding terminals 330 branched from the body portion 310 and protruding radially of the terminal holder 280a and 280b and connected to the end portion of the coil 240.

In this case, when the terminal is manufactured by punching the sheet metal material P in a net pattern through press processing, if the end portion 312 of the connection terminal 320 is formed in a direction crossing the body portion 310, as illustrated in FIG. 9, a lot of scraps S are generated, thereby increasing the material costs.

Accordingly, according to the present embodiments, since the connection terminal 320 is formed side by side with the body portion 310 in a twist-bendable shape, as illustrated in FIGS. 10 and 11, it is possible to reduce the amount of scraps S generated during press processing, thereby reducing material costs.

Accordingly, as illustrated in FIGS. 4 to 7, one or more of the plurality of phase terminals 260 include the body portion 310 bent with a predetermined curvature along the circumferential direction and supported by the terminal holder 280a and 280b, the connection terminal 320 formed side by side with the body portion 310 in the length direction of the body portion 310 and bent so that the end portion thereof faces upward to be electrically connected to the power supply unit, and the plurality of binding terminals 330 branched from the body portion 310 and protruding radially of the terminal holder 280a and 280b and connected to the end portion of the coil 240.

The body portion 310 is bent with a predetermined curvature along the circumferential direction of the terminal holder 280a and 280b to be supported by the terminal holder 280a and 280b, and the body portions are formed to have different diameters so that the respective terminals do not overlap each other.

For example, the diameters of the body portion of the first phase terminal 262, the body portion of the second phase terminal 264, the body portion of the third phase terminal 266, and the body portion of the neutral terminal 270 may be sequentially increased or sequentially decreased.

The connection terminal 320 is formed side by side with the body portion 310 in the length direction of the body portion 310 and is bent so that the end portion thereof faces upward and is electrically connected to the power supply unit.

More specifically, the connection terminal 320 includes a first connection portion 322 extending from the body portion 310 in the length direction, a first bent portion 324 bent along a first notch 323 extending from the first connection portion 322 in the length direction and formed in the diagonal direction, and a contact portion 326 bent along the second notch 325 extending from the first bent portion 324 in the length direction and formed in the diagonal direction and protruding upward of the terminal holder 280a and 280b.

The first connection portion 322 is formed to protrude from the body portion 310 in a horizontal direction in a shape in which one side or the other side of the body portion 310 extends in the length direction.

The first bent portion 324 is bent obliquely along the first notch 323 formed in the diagonal direction in a shape extending from one side or the other end portion of the first connection portion 322 in the length direction and protrudes in the inward or outward direction.

The contact portion 326 is bent along the second notch 325 formed in the diagonal direction in a shape extending from one side or the other end portion of the first bent portion 324 in the length direction, faces the first connection portion 322, and protrudes upward of the terminal holder 280a and 280b.

In other words, the contact portion 326 is spaced apart from the first connection portion 322 by a predetermined gap by the first bent portion 324, and is bent in a direction crossing the first connection portion 322 by the first notch 323 and the second notch 325 to protrude upward from the terminal holder 280a and 280b and is connected to the power supply unit.

In this case, the connection terminal 320 may include the first connection portion 322, the first notch 323, and the contact portion 326, and the contact portion 326 may be bent by the first notch 323 to overlap the first connection portion 322 and protrude upward from the terminal holder 280a and 280b to be connected to the power supply unit.

Here, the first notch 323 is formed on the outer surface or the inner surface of the connection terminal 320 to form an angle of about 45° to be inclined from an upper portion of one side to a lower portion of the other side, and the second notch 325 is formed on the outer surface or the inner surface of the connection terminal 320 to form an angle of about 45° to be inclined from an upper portion of one side to a lower portion of the other side to be spaced apart from the first notch 323 by a predetermined gap.

Accordingly, the contact portion 326 is perpendicular to the first connection portion 322 and protrudes upward from the terminal holder 280a and 280b to be connected to the power supply unit. As the connection terminal 320 is twist-bent in a direction crossing the body portion 310, the rigidity of the connection terminal 320 may be increased compared to the structure of being bent to overlap.

Further, the binding terminal 330 includes a second connection portion 332 extending upward from a portion of the body portion 310, a second bent portion 334 extending laterally from a portion of the second connection portion 332 and bent, and protruding radially of the terminal holder 280a and 280b, and a first bending portion 336 extending from an end portion of the second bent portion 334 and connecting to the coil 240.

The second connection portion 332 has a shape extending upward from a portion of the body portion 310 and protrudes from the body portion 310 in a vertical direction.

The second bent portion 334 extends laterally from a portion of the second connection portion 332 and is bent, and protrudes radially of the terminal holder 280a and 280b.

The first bending portion 336 extends from an end portion of the second bent portion 334 and is bent to one side or the other side to surround the end portion of the coil 240, and is connected to the coil 240.

The terminal of the busbar 250 according to another embodiment is formed in a direction opposite to the second bent portion 334 from any one second connection portion 332 so that the connection terminal 320 is positioned above the binding terminal 330, and the terminal of the busbar 250 according to another embodiment is formed in a direction opposite to the second bent portion 334 from any one second connection portion 332 so that the connection terminal 320 is positioned at a height corresponding to the binding terminal 330.

The neutral terminal 270 connects the neutral lines of the coils connected to the respective phases U, V, and W, and in the present embodiments, four neutral terminals are provided and disposed outside the phase terminals.

As illustrated in FIG. 8, the plurality of neutral terminals 270 include a body portion 310 bent with a predetermined curvature along the circumferential direction and supported by the terminal holder 280a and 280b, and a plurality of binding terminals 340 branched from the body portion 310, protruding radially of the terminal holder 280a and 280b, and connected to an end portion of the coil 240.

The body portion 310 is bent with a predetermined curvature along the circumferential direction of the terminal holder 280a and 280b to be supported by the terminal holder 280a and 280b, and are formed within a predetermined angle so that the respective terminals do not overlap each other, and one end portion or two opposite end portions thereof are bent outward.

The binding terminal 340 may include a third connection portion 342 extending downward from a portion of the body portion 310, a third bent portion 344 extending laterally from a portion of the third connection portion 342 and protruding radially of the terminal holder 280a and 280b, and a second bending portion 346 extending from an end portion of the third bent portion 344 and connecting to the coil 240.

The third connection portion 342 has a shape extending downward from a portion of the body portion 310 and protrudes from the body portion 310 in a vertical direction.

In this case, the third connection portion 342 may be formed to protrude in a direction perpendicular to the body portion 310 in a shape extending upward from a portion of the body portion 310.

The third bent portion 344 extends laterally from a portion of the third connection portion 342 and is bent, and protrudes radially of the terminal holder 280a and 280b.

The second bending portion 346 extends from an end portion of the third bent portion 344 and is bent to one side or the other side to surround the end portion of the coil 240, and is connected to the coil 240.

Subsequently, referring to FIGS. 10 and 11, a state in which a terminal of a busbar 250 is punched in a net pattern on a sheet metal material P by press processing is described with a plan view.

A terminal of a busbar 250 supported on a terminal holder 280a and 280b of a motor to be electrically connected to a power supply unit and connected to a coil 240 includes a body portion 310 bent with a predetermined curvature and supported by the terminal holder 280a and 280b, a connection terminal 320 formed side by side with the body portion 310 in a length direction of the body portion 310 and bent so that an end portion thereof faces upward to be electrically connected to the power supply unit, and a plurality of binding terminals 330 extending from a portion of the body portion 310 and protruding radially of the terminal holder 280a and 280b.

The body portion 310 is bent with a predetermined curvature along the circumferential direction of the terminal holder 280a and 280b to be supported by the terminal holder 280a and 280b, and the body portions are formed to have different diameters so that the respective terminals do not overlap each other.

For example, the diameters of the body portion of the first phase terminal 262, the body portion of the second phase terminal 264, the body portion of the third phase terminal 266, and the body portion of the neutral terminal 270 may be sequentially increased or sequentially decreased.

The connection terminal 320 is formed side by side with the body portion 310 in the length direction of the body portion 310 and is bent so that the end portion thereof faces upward and is electrically connected to the power supply unit.

More specifically, the connection terminal 320 includes a support portion 321 connected to one side of the body portion 310 through a first bent line L1 and bent outward or inward of the terminal holder 280a and 280b when assembled, a first connection portion 322 connected to one side of the support portion 321 through a second bent line L2 and bent in a length direction of the body portion 310 when assembled, a first bent portion 324 connected to one side of the first connection portion 322 through a third bent line L3 and bent outward or inward of the terminal holder 280a and 280b when assembled, and a contact portion 326 connected to one side of the first bent portion 324 through a fourth bent line L4, spaced apart from the first connection portion 322 when assembled, and bent in a direction facing the first connection portion 322.

The support portion 321 is connected to one side of the body portion 310 through the first bent line L1 and, when assembled, bent in an outward direction or an inward direction of the terminal holder 280a and 280b with respect to the first bent line L1.

The first connection portion 322 is connected to one side of the support portion 321 through the second bent line L2 and, when assembled, bent in the length direction of the body portion 310 with respect to the second bent line L2.

The first bent portion 324 is connected to one side of the first connection portion 322 through the third bent line L3 and, when assembled, bent in the outward or inward direction of the terminal holder 280a and 280b with respect to the third bent line L3.

The contact portion 326 is connected to one side of the first bent portion 324 through the fourth bent line L4, is spaced apart from the first connection portion 322 by a predetermined gap with respect to the fourth bent line L4 when assembled, and is bent in a direction facing the first connection portion 322.

In other words, the contact portion 326 is spaced apart from the first connection portion 322 by a predetermined gap by the first bent portion 324, and is bent in a direction crossing the first connection portion 322 by the third bent line L3 and the fourth bent line L4 to protrude upward from the terminal holder 280a and 280b and is connected to the power supply unit.

Here, the third bent line L3 is formed to form an angle of about 45° to be inclined from an upper portion of one side to a lower portion of the other side of the connection terminal 320, and the fourth bent line L4 is formed to form an angle of about 45° to be inclined from an upper portion of one side to a lower portion of the other side of the connection terminal 320 to be spaced apart from the third bent line L3 by a predetermined gap.

Accordingly, the contact portion 326 is perpendicular to the first connection portion 322 and protrudes upward from the terminal holder 280a and 280b to be connected to the power supply unit.

As such, as the connection terminal 320 is twist-bent in a direction crossing the body portion 310, the rigidity of the connection terminal 320 may be increased compared to the structure of being bent to overlap.

Further, the binding terminal 330 includes a second connection portion 332 formed to extend upward from a portion of the body portion 310, a second bent portion 334 connected to the other side of the second connection portion 332 through a fifth bent line L5 and, when assembled, bent outward of the terminal holder 280a and 280b, and a first bending portion 336 connected to the other side of the second bent portion 334 through a sixth bent line L6 and, when assembled, bent to be connected to the coil 240.

The second connection portion 332 has a shape extending upward from a portion of the body portion 310 and is connected from the body portion 310 in a vertical direction.

The second bent portion 334 is connected to the other side of the second connection portion 332 through the fifth bent line L5 and, when assembled, bent to protrude outward of the terminal holder 280a and 280b with respect to the fifth bent line L5.

The first bending portion 336 is connected to the other side of the second bending portion 334 through the sixth bending line L6 and, when assembled, bent with respect to the sixth bending line L6 and connected to the coil 240.

In this case, a plurality of binding terminals 330 are formed to correspond to the number of three-phase power lines of U, V, and W, and the plurality of binding terminals 330 are formed to be spaced apart from each other at regular intervals along the length direction of the body portion 310.

As described above, according to the present embodiments, since the connection terminal 320 is formed side by side with the body portion 310 in a twist-bendable shape, the amount of scraps S generated during press processing may be reduced, thereby reducing material costs, and as the connection terminal 320 is twisted-bending in a direction crossing the body portion 310 during assembly, rigidity may be increased.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed:

1. A terminal of a busbar, comprising:
a body portion configured to be bent with a predetermined curvature and supported by a terminal holder of a motor;
a connection terminal formed side by side with the body portion in a length direction of the body portion and configured to be connected to a coil; and
a plurality of binding terminals extending from a portion of the body portion, and configured to be radially protruded from the terminal holder,
wherein the connection terminal comprises:
a support portion connected to one side of the body portion through a first bent line and configured to be bent in an outward or inward direction of the terminal holder;
a first connection portion connected to one side of the support portion through a second bent line and configured to be bent in the length direction of the body portion;
a first bent portion connected to one side of the first connection portion through a third bent line and configured to be bent in an outward or inward direction of the terminal holder; and
a contact portion connected to one side of the first bent portion through a fourth bent line and configured to be bent in a direction facing the first connection portion and spaced apart from the first connection portion by a predetermined gap.

2. The terminal of claim 1, wherein the third bent line is formed to be inclined with respect to the second bent line.

3. The terminal of claim 2, wherein the fourth bent line is formed to be inclined with respect to the second bent line, and to be spaced apart from the third bent line by a predetermined gap.

4. The terminal of claim 1, wherein each of the plurality of binding terminals comprises:
a second connection portion formed to extend upward from a portion of the body portion;
a second bent portion connected to one side of the second connection portion through a fifth bent line, and configured to be bent in an outward direction of the terminal holder; and
a first bending portion connected to one side of the second bent portion through a sixth bent line, and configured to be bent to be connected to the coil.

5. The terminal of claim 1, wherein the plurality of binding terminals are formed to be spaced apart from each other by a predetermined gap along the length direction of the body portion.

6. A terminal of a busbar, comprising:
a body portion configured to be bent with a predetermined curvature and supported by a terminal holder of a motor; and
a connection terminal formed side by side with the body portion in a length direction of the body portion, wherein the connection terminal has a contact portion configured to be bent upward to receive power supply and to be connected to a coil.

7. The terminal of claim 6, wherein the connection terminal comprises:
a first connection portion extending from the body portion in the length direction of the body portion;
a first bent portion configured to be bent along a first notch, which is extending from the first connection portion in a length direction of the first connection portion, and is formed in a diagonal direction; and
a contact portion configured to be bent along a second notch, which is extending from the first bent portion in a length direction of the first bent portion, and is formed in the diagonal direction, wherein the contact portion is configured to be protruded upward of the terminal holder.

8. The terminal of claim 7, wherein the contact portion is configured to bent in a direction crossing the first connection portion by the first notch and the second notch, and be spaced apart from the first connection portion by a predetermined gap by the first bent portion.

9. The terminal of claim 7, wherein the first notch is formed in an outer surface or inner surface of the connection terminal to be inclined with respect to the length direction of the body portion.

10. The terminal of claim 9, wherein the second notch is formed in an outer surface or inner surface of the connection terminal to be inclined with respect to the length direction of the body portion, and to be spaced apart from the first notch by a predetermined gap.

11. The terminal of claim 6, further comprising a plurality of binding terminals extending from a portion of the body portion, and configured to be protruded from the terminal holder.

12. The terminal of claim 11, wherein each of the plurality of binding terminals comprises:
a second connection portion formed to extend upward from a portion of the body portion;
a second bent portion extending in a lateral direction from a portion of the second connection portion, and configured to be bent and radially protruded from the terminal holder; and
a first bending portion extending from an end portion of the second bent portion, and configured to be bent and connected to the coil.

13. A motor, comprising:
a rotor coupled to a shaft;
a stator including a core disposed outside of the rotor, a winding portion mounted on the core, and a stator including a coil wound on the winding portion; and
a busbar including a plurality of phase terminals and a plurality of neutral terminals connecting to the coil and a terminal holder disposed on an upper side of the stator to support the phase terminals and the neutral terminals,
wherein at least one of the plurality of phase terminals comprises a body portion bent with a predetermined curvature along a circumferential direction and supported by the terminal holder and a connection terminal having a portion positioned in parallel with a length direction of the body portion and having an end portion bent upward to receive power supply from an external device.

14. The motor of claim 13, wherein the connection terminal comprises:
a first connection portion extending from the body portion in the length direction of the body portion;
a first bent portion bent along a first notch, which is extending from the first connection portion in a length direction of the first connection portion, and formed in a diagonal direction; and
a contact portion bent along a second notch, which is extending from the first bent portion in a length direction of the first bent portion, and formed in the diagonal direction, wherein the contact portion is protruded upward of the terminal holder.

15. The motor of claim 14, wherein the contact portion is bent in a direction crossing the first connection portion by the first notch and the second notch and is spaced apart from the first connection portion by a predetermined gap by the first bent portion.

16. The motor of claim 14, wherein the first notch is formed in an outer surface or inner surface of the connection terminal to be inclined with respect to the length direction of the body portion.

17. The motor of claim 16, wherein the second notch is formed in an outer surface or inner surface of the connection terminal to be inclined with respect to the length direction of the body portion, and to be spaced apart from the first notch by a predetermined gap.

18. The motor of claim 13, wherein the coil comprises power lines of three phases of U, V, and W and neutral lines disposed to sequentially correspond to the three phases along a circumferential direction of the coil, and
wherein the plurality of phase terminals comprise a first phase terminal, a second phase terminal, and a third phase terminal, which are connected to respective phases.

19. The motor of claim 18, wherein the first phase terminal or the second phase terminal or the third phase terminal comprises a plurality of binding terminals extending from a portion of the body portion and radially protruding from the terminal holder.

20. The motor of claim 19, wherein each of the plurality of binding terminals comprises:
a second connection portion formed to extend upward from a portion of the body portion;
a second bent portion extending in a lateral direction from a portion of the second connection portion and bent, and radially protruding from the terminal holder; and
a first bending portion extending from an end portion of the second bent portion and bent, and being connected to the coil.
